(19) United States
(12) Patent Application Publication
(10) Pub. No.: US 2005/0129283 A1
(43) Pub. Date: Jun. 16, 2005

(54) Braille paper UI

(75) Inventors: Denise M. Butler, Rochester, NY (US); Mathew J. Walczyk, Macedon, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/736,663

(22) Filed: Dec. 16, 2003

(51) Int. Cl. G06K 9/00; H04N 1/04

(52) U.S. Cl. 382/114; 382/219; 358/474

(57) ABSTRACT

A method for making written documents available to the visually impaired. The method includes generating a cover sheet that has both machine readable information and tactilely readable information and scanning a document using the cover sheet. A cover sheet for scanning a document, which includes machine readable markings and tactilely readable markings.

The present invention relates to using multifunction devices and more specifically to intelligent scanning of documents.

The widespread availability of optical scanners, facsimile (fax) machines, multifunction devices, and other devices and subsystems by which computers and computer networks can “read” paper documents has given rise to the concept of a paper-based user interface. A paper-based user interface allows the user of a computer, computer network, or other digital information processing system to communicate with the system simply by making a mark or marks on a paper document or documents and then scanning the document thus marked into the system via a scanner, fax machine, multifunction device, or the like.

A paper-based user interface can serve as a complement or substitute for the more conventional keyboard-mouse-display type of user interface mentioned earlier. A paper-based user interface is particularly appealing when the user interacts with a computer network directly through a multifunction device, without recourse to a personal computer or workstation. In this situation, the user can initiate a number of functions, such as document copying, facsimile, electronic mail, document storage, and search using a simple paper form as an interface. The multifunction device 10 “reads” what is on the form and responds accordingly, possibly with help from the network.

Paper-based user interfaces typically require that forms be created in advance, either by the user with a form editor or automatically by computer, so that the receiving computer can readily determine whether and where a given form has been marked by a user. For example, specially coded information, such as a pattern of data glyphs or a bar code, can be included in the form itself to indicate the instructions to the device. The device (or a computer networked to the device) can be programmed in this case to seek the coded information at a predesignated location within the received image, and to use the coded information together with additional (stored or preprogrammed) information to determine what is to be done.

In particular, exemplary paper-based user interfaces are known that allow a user to designate what happens to a scanned version of a hard copy document. FlowPort™ is one such system. The user accesses a website where she creates a cover sheet for the scan job. The cover sheet includes markings called glyphs that contain instructions regarding the document to be scanned. These instructions can include, but are not limited to, what format the scanned document will take and to where or who the document will be sent.

In considering the applications of Section 508 of the Americans with Disabilities Act (29 U.S.C. § 794d), business equipment will have to be designed to allow for easier access by a wider body of users, with a variety of physical limitations.

As 508 compliance becomes a design goal, assistive user interfaces are being developed to allow blind or low vision users to independently use a walkup copier or multifunction device. A logical extension of these designs is a method for allowing those same users to independently determine the characteristics of their original in order to increase their overall successful use of these devices. This invention will allow for this.

Enabling the visually impaired to use a paper UI allows them to scan documents they cannot read and extract information from them. If a visually impaired person scans a document to herself, she then can take advantage of screen readers and other technology to hear the information rather than read it.

Embodiments include a paper UI method and apparatus for the visually impaired. A cover sheet for scanning a document which includes a first area where a first set of information is encoded in a machine readable form, and a second area where a second set of information is encoded in a tactilely readable form. The first set of information includes instructions relating to what should happen with a scanned document. A method for scanning documents includes generating a cover sheet having machine readable information including instructions for the output of the scan job, at least one user-selectable parameter, and tactilely readable information relating to the user selectable parameter. The method also includes tactilely reading the cover sheet and selecting the at least one user-selectable parameter.

Various exemplary embodiments will be described in detail, with reference to the following figures, wherein:

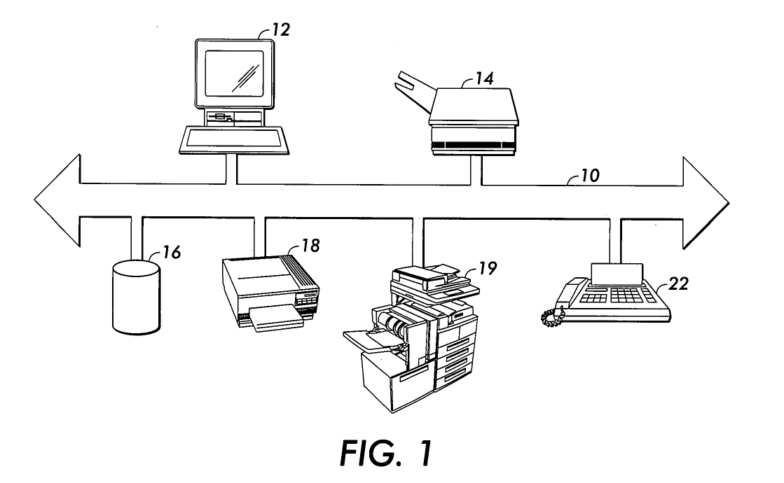

FIG. 1 is simplified diagram showing a networked document services system in which the present invention can be useful.

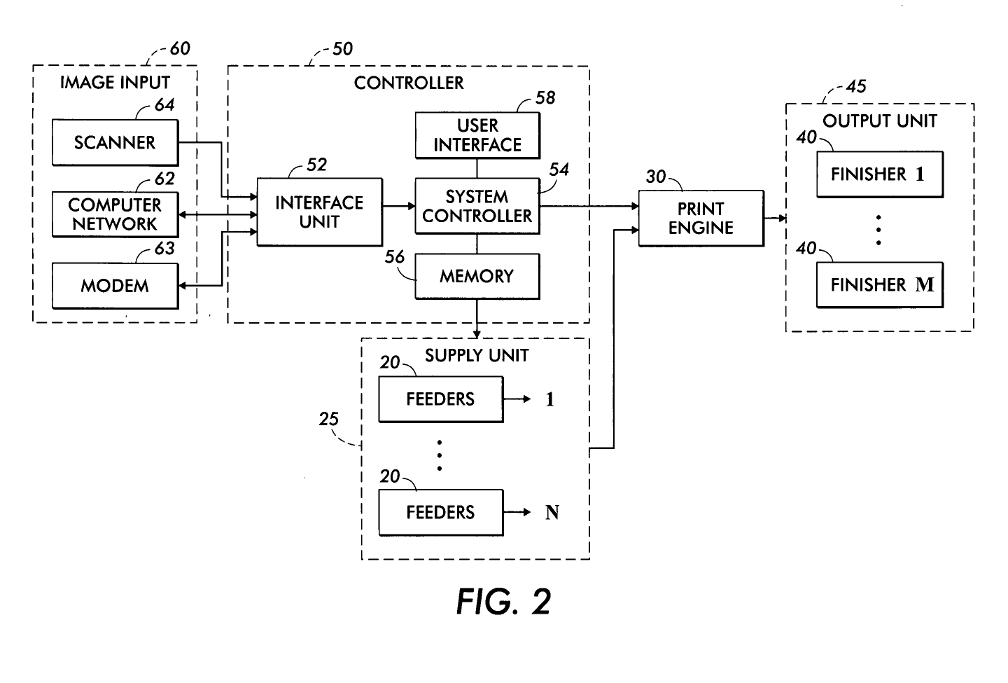

FIG. 2 is a general block diagram of elements of a multifunction device such as the one shown in FIG. 1

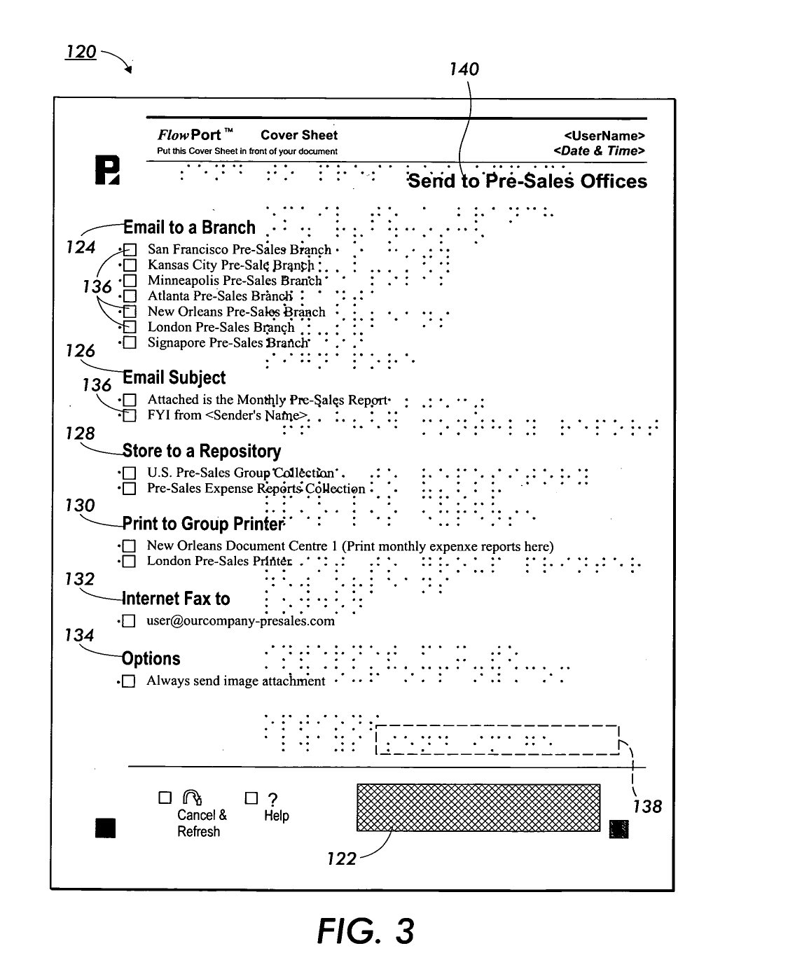

FIG. 3 illustrates an exemplary embodiment of a cover sheet for scanning a document having multiple selectable choices thereon.

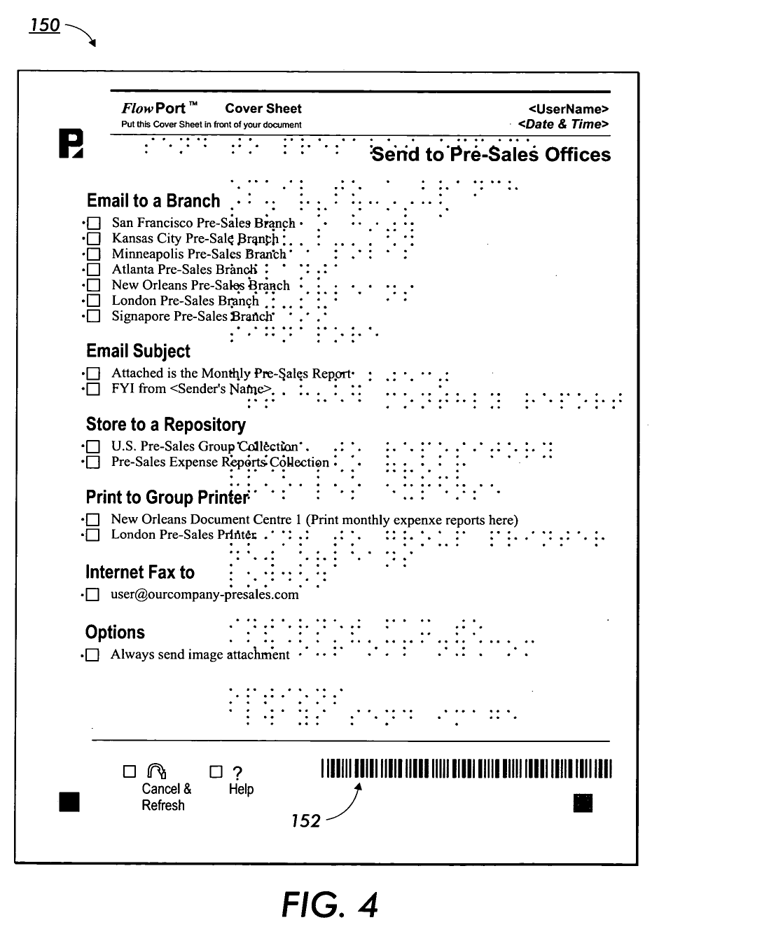

FIG. 4 illustrates a second exemplary embodiment of a cover sheet for scanning a document having multiple selectable choices thereon.

FIG. 1 is a simplified diagram showing an example of a networked document-services system in which the present invention is useful. A network bus 10, which may be of any type known in the art, such as Ethernet or Token-Ring, interconnects a number of computers and peripherals. For example, on network 10 there would be typically any number of personal computers such as 12, scanners such as 14, shared memories such as 16, a desktop printer such as 18, and a multifunction device such as 19. The network 10 may further interconnect a fax machine 22, which in turn connects with a standard telephone network. Network 10 may also connect to the Internet. What is important is that the various computers and peripherals can interact to perform various document services.

FIG. 2 shows a schematic illustration of the interior workings of the multifunction device 19. An image input section 60 transmits signals to the controller 50. In the example shown, image input section 60 has both remote and onsite image inputs, enabling the multifunction device 19 to provide network, scan and print services. Also note that although referred to as an image input section, output may also occur through computer network 62 and modem 63. Users may send images through the computer network 62 to be printed by the device 19, or images scanned by scanner 64 may be sent out through the network 62. The same is true with modem 63. The data passes through interface unit 52 in the controller 50. The multifunction device 19 can be coupled to multiple networks or scanning units, remotely or onsite. While a specific multifunction device is shown and described, the present invention may be used with other types of printing systems such as analog printing systems.

For on-site image input, an operator may use the scanner 64 to scan documents, which provides digital image data including pixels to the interface unit 52. Whether digital image data is received from scanner 64 or computer network 62, the interface unit 52 processes the digital image data in the form required to carry out each programmed job. The interface unit 52 is preferably part of the device 19. However, the computer network 62 or the scanner 64 may share the function of converting the digital image data into a form, which can be used by the device 19.

The multifunction device 19 includes one or more (1 to N) feeders 20, a print engine 30, one or more (1 to M) finishers 40 and a controller 50. Each feeder 20 typically includes one or more trays, which forward different types of support material to the print engine 30. All of the feeders 20 in the device 19 are collectively referred to as a supply unit 25. All of the finishers 40 are collectively referred to as an output unit 45. The output unit 45 may comprise several types of finishers 40 such as inserters, stackers, staplers, Braille embossers, binders, etc., which take the completed pages from the print engine 30 and use them to provide a finished product.

The controller 50 controls and monitors the entire multifunction device 19 and interfaces with both on-site and remote input units in the image input section 60. The controller 50 includes the interface unit 52, a system control unit 54, a memory 56 and a user interface 58. The system control unit 54 receives print engine information from sensors throughout the multifunction device 19. The user interface 58 includes an area where the user can monitor the various actions of the device 19. The user interface 58 also permits an operator to control what happens to a scanned document or print job, including directing how it will be outputted and where it will go; e.g., the output unit 45 or the modem or the Internet.

In addition to the user interface 58 present on the multifunction device 19 itself, other user interfaces are available to the user. For example, the user may electronically send documents from a remote PC connected through the network 10 and control what happens to those documents through a local user interface (UI). Users may also use the scanner 64 to command the multifunction device 10 through a paper UI.

Paper-based user interfaces typically require that forms be created in advance, either by the user with a form editor or automatically by computer, so that the receiving computer can readily determine whether and where a given form has been marked by the user. For example, suppose that a particular form contains a set of blank boxes in which the user can enter check-marks or Xs to indicate certain requests. The user selects the form, checks some of the boxes, scans the form into the system to produce a digital image, and transmits this image (more precisely, transmits data representing the image) to a computer. Upon receiving the transmitted image of the user's marked-up form, the computer compares the image with a stored representation of the unmarked form. Based on the results of the comparison, the computer can tell what the user has requested and take any action appropriate in response.

In order to make the comparison, however, the computer must first have the information necessary to interpret the form, such as information about where the blank boxes are located on the form, how big the boxes are, and what each box means, that is, how the computer should respond when certain boxes are marked. This information can be provided to the computer either in advance of the user's transmission, or concurrently with or as part of the user's transmission. For example, the computer can be given access to a set of stored digital representations each indicating the layout or appearance of one of a set of forms, and the user can transmit along with the marked-up form image an identification number that uniquely corresponds to the particular type of form being used.

As another example, specially coded information, such as a pattern of data glyphs or a bar code, can be included in the form itself to indicate the layout of the blank fields in the form. The computer can be programmed in this case to seek the coded information at a predesignated location within the received image, and to use the coded information together with additional (stored or preprogrammed) information to identify what kind of form has been sent and to determine what is to be done in response to the boxes checked by the user.

FIG. 3 illustrates an exemplary embodiment of a form 120 for a paper-based UI system. A user would place the form 120 on top of a document and then place both it and the document into the scanner 64. When the device 19 scans in the document and form 120, the device, or a computer operably connected to the device either directly or through the network, reads the information present on the face of form 120 and processes the document according to that information. The information is usually embedded with machine readable information 122 printed on the face of the form 120. That information may contain the computer instructions themselves or it may contain an electronic address and a form identification code where the scanned data is sent to the address and the information thereon is interpreted depending on which form code was embedded. There are, of course, other systems possible and the exact nature of the information contained within the machine readable information 122 should not be considered limiting.

In the illustrated embodiment, the machine readable information 122 is in the form of glyphs. In this case, the form 120 uses the glyphs 122 to convey instructions to the multifunction device 10 or to an attached computer regarding the document. While glyphs are shown, other machine readable means of conveying information, such as bar codes, may be used as well. FIG. 4 illustrates a paper UI cover sheet 150 having machine readable information in the form of a bar code 152.

The form 120 also includes a plurality of user selectable features. The user selectable features include a listing of potential email recipients 124, a plurality of subject lines for any email sent 126, a plurality of databases 128 into which the data may be stored, a plurality of networked printers 130 to which the document may be sent, an internet fax address 132 to which the document may be sent, and an option 134 for sending an image attachment.

Next to each user selectable feature is an empty box 136 that the user may select. The boxes 136 could be manually checked or automatically checked by the device when the form was originally generated. For example, users may generate paper UI coversheets at a remote location on a PC or other device where the user would select desired features before printing the form. However, a series of generic forms such as the form 120 may be generated with a list of common selections the user may make.

Additionally, while not shown in FIGS. 3 and 4, the “cancel and refresh” and “help” user selections could also be represented in Braille for the user. The user may wish to select the “cancel and refresh” option in particular, because when the form is scanned in again, another form identical to the first will be printed.

The user selectable features shown on sheet 120 are nonexhaustive and a variety of others could be easily and immediately contemplated. The specific features listed on sheet 120 should in no way be considered limiting. Also, in embodiments, the form may contain only one user selectable feature, such as an email address. However, these will usually be pregenerated by the user with the box 136 already checked.

FIG. 3 also includes tactilely readable information 138, which in the embodiment shown is in a Braille format. The tactilely readable information 138 would contain information that would help visually impaired users use the paper UI. Specifically, the tactilely readable information could contain, for example, the title 140 of the form 120, the user selectable features 124, 126, 128, 130, 132, 134 available to the user on the face of the sheet. The tactilely readable information 138 may also contain other information such as, for example, the purpose of the sheet and an identification of who generated the sheet.

Having information encoded tactilely provides several advantages for visually impaired users. First, it allows them to identify a form they may have generated elsewhere. Using other technologies such as screen readers and voice recognition software, a user may have generated the form 120 from her desk and sent it to a printer for completion. In a typical office setting, the user would be unlikely to figure out which sheet was the form she generated at a shared printer. However, if one of the finishers 40 was an embosser, the user would be able to determine which sheet was hers relatively quickly. The tactilely readable information 138 might include her name/username or the title 140 of the form 120.

The tactilely readable information 138 also allows the user to identify an already prepared form from a form library or folder that may be located near a device. Commonly used forms may be kept near a multifunction device because they are used frequently by various persons in an office. A visually impaired person would be able to take advantage of the forms if they had a tactilely readable area identifying its purpose any selections the user needs to make.

Identification of user selectable features 124, 126, 128, 130, 132, 134 is another important purpose for the tactilely readable area 138. For example, the user may select a form, such as the form 120, from a folder next to a multifunction device. The user would read the tactilely readable areas on each form to determine which form she wanted to use. Once she decided upon a form she may be required to make selections on the form itself. If she wanted to use the form 120 in FIG. 2, for example, she could read the tactilely readable information 138 available and determine what features were available for selection on the left-hand side. She could then locate the correct checkbox by feeling for the correct bump to the left of the description on the form, which she would mark.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents, and other publications cited herein are incorporated by reference in their entirety.

1. A method for making written documents available to the visually impaired, comprising:
generating a cover sheet including
machine readable information, and
tactilely readable information; and
scanning a document using the cover sheet.

2. The method of claim 1, wherein the document includes at least one user-selectable parameter, and the method further comprises
selecting the at least one user-selectable parameter.

3. The method of claim 2, wherein selecting the at least one user-selectable parameter includes checking a box on the sheet.

4. The method of claim 2, wherein the at least one user selectable parameter includes at least one email address.

5. The method of claim 2, wherein the at least one user selectable parameter includes a database.

6. The method of claim 2, wherein the at least one user selectable parameter includes a group printer.

7. The method of claim 1, further comprising tactilely reading the cover sheet.

8. A cover sheet for scanning a document, comprising:
machine readable markings; and
tactilely readable markings.

9. The cover sheet of claim 8, wherein the sheet also contains user selectable markings.

10. The sheet of claim 9, wherein the tactilely readable markings includes a description of the user-selectable features.

11. The sheet of claim 9, wherein the user selectable markings include at least one email address.

12. The sheet of claim 8, wherein the tactilely readable markings include Braille.

13. The sheet of claim 8, wherein the machine readable markings include a bar code.

14. The sheet of claim 8, wherein the machine readable markings includes glyphs.
